(19) United States
(12) Patent Application Publication
(10) Pub. No.: US 2012/0268780 A1
(43) Pub. Date: Oct. 25, 2012

(54) INFORMATION PROCESSING APPARATUS AND IMAGE OUTPUT SYSTEM

(75) Inventor: Shinichi KAWANO, Osaka (JP)

(73) Assignee: SHARP KABUSHIKI KAISHA, Osaka (JP)

(21) Appl. No.: 13/445,298

(22) Filed: Apr. 12, 2012

(30) Foreign Application Priority Data
Apr. 19, 2011 (JP) 2011-092857

(51) Int. Cl. G06F 3/12

(52) U.S. Cl. 358/1.15

(57) ABSTRACT

An information processing apparatus searches the image output apparatus connected to a network according to an image output system decided based on user operation and obtains device information and state information thereof. Then, the device information and the state information are displayed on a search result display portion of a display screen. At the time, on the search result display portion, the image output apparatus is displayed in ascending order of power consumed up until image output is able to be performed based on the state information of the searched image output apparatus. A user performs an operation to arbitrarily select the image output apparatus displayed on the search result display portion, so as to execute image output processing desired by the user by the selected image output apparatus.

### CROSS-NOTING PARAGRAPH

This non-provisional application claims priority under 35 U.S.C. §119(a) on Patent Application No. 2011-092857 filed in JAPAN on Apr. 19, 2011, the entire contents of which are hereby incorporated herein by reference.

### FIELD OF THE INVENTION

The present invention relates to an information processing apparatus and an image output system, and more specifically, to an information processing apparatus for displaying a search result of an image output apparatus connected to a communication network and an image output system comprised of the information processing apparatus and the image output apparatus.

### BACKGROUND OF THE INVENTION

Image output apparatuses which outputs image data transmitted from information processing apparatuses such as a PC (Personal Computer) have been spread in recent years. The image output apparatuses include a printer with only a print function, a Multifunction Peripheral (MFP or the like) provided with, in addition to the print function, a scanner function, a data transmission/reception function by way of FAX, an E-mail, etc., and the like, or a tablet terminal or a portable terminal which displays and outputs image data on a display screen without the print function.

These image output apparatuses perform wired or wireless connections to a network such as a LAN most of the times, and for example, in an office, a plurality of output apparatuses are installed at a plurality of places. A user is able to select an image output apparatus for use in consideration of the installed place of the image output apparatus, a function supported by the image output apparatus and the like.

For example, Japanese Laid-Open Patent Publication No. 2009-26206 presents a print system in which, under a network environment to which a plurality of printers are connected, when a user transmits a print job to a printer server from a printer driver, the print server searches a printer in a ready state which does not need warm up on the network so that the print job is transmitted to the printable printer. According to the print system, a user is able to avoid a latency time due to the warm up of the printer.

However, the print system described in Japanese Laid-Open Patent Publication No. 2009-26206 is not a system configured to search a plurality of image output apparatuses connected to the network, or to allow a user to select the image output apparatus for use, and furthermore, it is not a system which targets a tablet terminal or a portable terminal without the print function as the image output apparatus. Then, the print system is not a system in which power consumption or the like is not taken into account in the order of display, when displaying an image output apparatus found out by search.

### SUMMARY OF THE INVENTION

To solve the above-described problems, an object of the present invention is to provide an information processing apparatus for searching a device which is able to perform image output and displaying in order of power consumed up until image output so as to allow a user to acknowledge a usable apparatus appropriately and use it for image output, and an image output system comprised of the information processing apparatus and an image output apparatus.

An object of the present invention is to provide an information processing apparatus which is connectable to a plurality of image output apparatuses via a communication network, comprising: a search portion for searching the image output apparatus connected to the communication network, and obtaining device information unique to the image output apparatus including function information indicating a function of image output processing executable by the image output apparatus and state information indicating a state of the image output apparatus; a storage portion for storing a search result by the search portion; a display portion for displaying the search result stored in the storage portion; and a display control portion for controlling display of the display portion; wherein the display control portion distinguishes power consumed up until image output is performed for each image output apparatus based on the device information and the state information obtained from the searched image output apparatus, and displays on the display portion information indicating the image output apparatuses in ascending order of the power consumption.

Another object of the present invention is to provide the information processing apparatus, further comprising an operation input portion for accepting operation input by a user, and a selection portion for selecting an output system of image data in accordance with operation input for the operation input portion, wherein the search portion distinguishes the image output apparatus capable of performing image output in the selected output system based on the device information obtained from the image output apparatus connected to the communication network, and stores the distinguished result in the storage portion as a search result.

Another object of the present invention is to provide the information processing apparatus, wherein the search portion searches, as search targets, an image forming apparatus for performing image formation and output of image data onto a recording medium, and an image display apparatus for performing display and output of image data on a display screen.

Another object of the present invention is to provide the information processing apparatus, further comprising a portion for transmitting the image data created by the information processing apparatus to the image forming apparatus connected via the communication network so that image formation is performed, wherein the display control portion extracts, when a predetermined image forming condition is set for the portion for performing image formation, the image forming apparatus as the image output apparatus, and displays on the display portion the extracted image forming apparatus in ascending order of the power consumption.

Another object of the present invention is to provide an image output processing system comprised of the information processing apparatus and the image output apparatus connected to the information processing apparatus via the communication network, wherein the image output apparatus transmits, in response to a request transmitted from the information processing apparatus, device information unique to the image output apparatus including function information indicating a function of image output processing executable by the image output apparatus and state information indicating a state of the image output apparatus.

### BRIEF DESCRIPTION OF THE DRAWINGS

FIG. 1 is a diagram for explaining an embodiment of an image output system according to the present invention;

FIG. 2 is a functional block diagram of an information processing apparatus and an image output apparatus constituting the image output system according to the present invention;

FIG. 3 is a flowchart for explaining an image output processing example in the image output system according to the present invention;

FIG. 4 is a diagram showing an example of a screen for activating a common format data generation portion of the image processing apparatus;

FIG. 5 is a diagram showing an example of a dialogue screen concerning print setting which is shifted from the screen of FIG. 4;

FIG. 6 is a diagram showing a display example of a search result by the information processing apparatus;

FIG. 7 is a diagram showing another display example of the search result by the information processing apparatus;

FIG. 8 is a diagram showing still another display example of the search result by the information processing apparatus;

FIG. 9 is a diagram showing still another display example of the search result by the information processing apparatus;

FIG. 10 is a flowchart for explaining another processing example of the image output system according to the present invention;

FIG. 11 is a diagram showing still another display example of the search result by the information processing apparatus;

FIG. 12 is a diagram showing still another display example of the search result by the information processing apparatus;

FIG. 13 is a diagram showing still another display example of the search result by the information processing apparatus;

FIG. 14 is a diagram showing still another display example of the search result by the information processing apparatus;

FIG. 15 is a diagram showing still another display example of the search result by the information processing apparatus;

FIG. 16 is a diagram showing still another display example of the search result by the information processing apparatus; and

FIG. 17 is a flowchart for explaining another example of image output processing by the image output system according to the present invention.

### PREFERRED EMBODIMENTS OF THE INVENTION

Hereinafter, description will be given for embodiments of the present invention with reference to accompanying drawings, which is provided for understanding of the present invention. Note that, the embodiments as described below show one example in which the present invention is specified, and are not to limit the technical scope of the present invention.

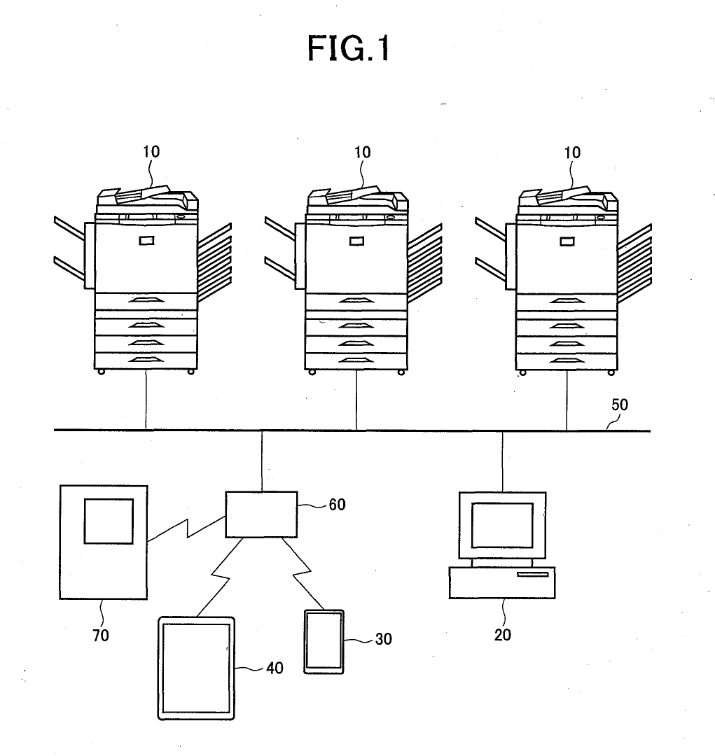

FIG. 1 is a diagram for explaining an embodiment of an image output system according to the present invention. In the image output system, an information processing apparatus 20 and image forming apparatuses 10 are connected via a network 50 such as the Internet or an intranet. Further, to the network 50, a tablet PC 40, a smartphone 30, an electronic device with a built-in wireless storage device 70 or the like is connectable via wireless communication portion 60 such as a wireless LAN port. The electronic device with a built-in wireless storage device 70 is an electronic device such as a digital camera provided with a memory card with a built-in wireless LAN as a wireless storage device. Some memory cards with the built-in wireless LAN correspond to a standard such as Wi-Fi (wireless fidelity) (Registered Trademark), IEEE802.11n or the like. Additionally, although it is not illustrated, for example, as a portable terminal device using electronic paper as a display, one which connects an electronic paper terminal to the network 50 such as an electronic book reader, various mobile phones or the like may be used.

The network 50 is an IP network or the like such as the intranet/Internet including a LAN (local Area Network), a wireless LAN, a WiMAX (Worldwide Interoperability for Microwave Access), PLC (Power Line Communication), c. LINK and the like, and also connectable to an external network.

The image forming apparatus 10 is provided with at least a print (image formation) function to print image data on a recording medium, and to which an apparatus such as a printer, a printer with a scanner function, a MultiFunction Printer/Product/Peripheral (MFP) or the like is applicable. Accordingly, output of image data is executed in a form of print output for the recording medium. Further, in the case of the apparatus with a communication function such as the MFP, the image output is executed by transmitting image data to an external device according to the function. In addition, to the network 50, one or a plurality of the image forming apparatus 10 are able to be connected.

The information processing apparatus 20 is an information processing apparatus such as a PC/AT compatible machine or a MAC (Macintosh) standard device, and may be a terminal such as a portable terminal of PDA (Personal Digital Assistant) or the like. Further, to the network 50, a plurality of information processing apparatuses 20 in the similar configuration are able to be connected.

The tablet PC 40, the smartphone 30, or the electronic device with a built-in wireless storage device 70 does not usually include the print function, and displays image data on its display screen. That is, output of the image data is performed in the form of display output. Furthermore, transmission of the image data to an external device may be performed.

In the present embodiment, the image output apparatus that is a search target of the information processing apparatus 20 includes the image forming apparatus 10, the tablet PC 40, the smartphone 30, or the electronic device with a built-in wireless storage device 70, the electronic paper terminal and the like as above described. As a form of the image output, forms such as print, display or external transmission may be employed according to the function provided with each network device as described above.

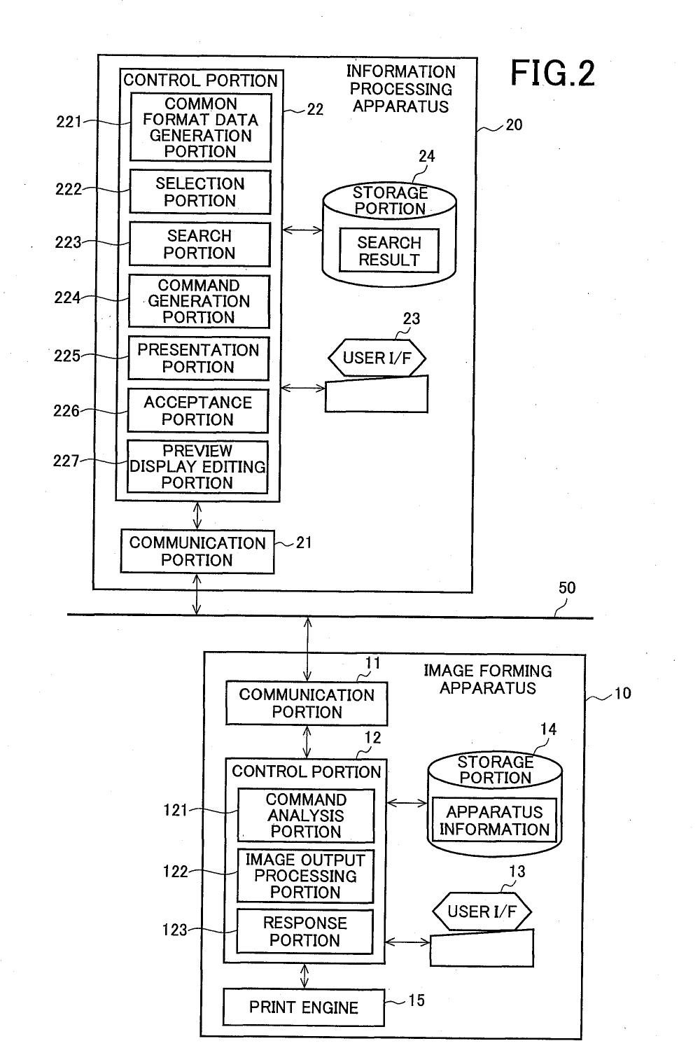

FIG. 2 is a functional block diagram of the information processing apparatus and the image output apparatus constituting the image output system according to the present invention. The information processing apparatus 20 is provided with a communication portion 21, a control portion 22, a user interface (I/F) 23, and a storage portion 24.

The control portion 22 has a common format data generation portion 221, a selection portion 222, a search portion 223, a command generation portion 224, a presentation portion 225, a acceptance portion 226 and a preview display editing portion 227. The control portion 22 has, as hardware, an arithmetic processing unit such as a CPU, and a memory such as a ROM, RAM or the like, and reads out and executes a program stored in the memory so as to realize various functions of the above control portion 22.

The user interface (I/F) 23 is comprised of a display portion and an operation input portion such as a keyboard or a mouse. Further, it may be configured by a touch panel in which the display portion and the operation input portion are integrated. On the display portion of the user interface 23, state information of the image output apparatus on the network 50 which is searched by the information processing apparatus 20 is displayed. Further, the operation input portion accepts operation input by a user for transmitting to the control portion 22.

The common format data generation portion 221 of the control portion 22 creates data in a common format for application data in various forms such as a document, a tabular statement, a vector diagram, a raster diagram, or a photograph created based on various application programs (software). The common format data generation portion 221 is one kind of a printer driver, and is able to be activated when printing is performed from an arbitrary application.

As a common format which is printable on an arbitrary image output apparatus, PDF (Portable Document Format), XPS (XML Paper Specification), XMDF (ever-eXtending Mobile Document Format) and the like may be used. In the present embodiment, the PDF is exemplified as the common format.

When common format data is started to be generated in the common format data generation portion 221, the selection portion 222 selects an output system of the common format data in accordance with operation input of a user for the user interface 23. The output system is to define the output system of image data in an external image output apparatus (image forming apparatus 10, tablet PC 40, smartphone 30, electronic device with a built-in wireless storage device 70, electronic paper terminal, etc.) which is connected to the network 50. As the output system, for example, it may be possible to select printing of image data, display of image data, transmission of image data to an external device or the like. For transmission of the image data, Fax transmission, I-Fax transmission, E-Mail transmission, FTP (File Transfer Protocol) transmission or the like is able to be selected. Any one of those may be selected, and a plurality of those may be executed at the same time.

When the output system is selected by the selection portion 222, the search portion 223 searches an image output apparatus which is connected to the network 50 via the communication portion 21. Here, the search portion 223 searches the image output apparatus which is able to output the common format data in the output system selected by the selection portion 222 from among one or a plurality of image forming apparatuses 10 connected to the network 50. For example, the selected output system is print output, the search portion 223 searches an image output apparatus provided with a print function, namely the image forming apparatus 10, from among the image output apparatuses connected to the network 50. Moreover, when the selected output system is display output, a search is performed for a device having a display screen which is able to display the common format data of the tablet PC 40, the smartphone 30, the electronic device with a built-in wireless storage device 70, the electronic paper terminal and the like. At the time, the search portion 223 is able to search by using SNMP (Simple Network Management Protocol) or WSD (WS-Discovery).

The search portion 223 performs a search on the network 50 by means of broadcast and obtains device information of a device which is able to perform image output in the output system selected by the selection portion 222. The device information to be obtained is a device name, an IP address and information of a function capable of performing image output in the common format. Further, as other device information, a display size of a display screen of a device, type information of a display device such as an LCD, electronic paper or the like may be obtained. The device name may include a product name and serial number information. Further, the above function information is information related to a function of the image output processing supported by the image output apparatus, including a print function, an image display function, an image data transmission function or the like. From the information of the device name, the type of the device such as the image forming apparatus 10, the tablet PC 40, the smartphone 30, the electronic device with a built-in wireless storage device 70, the electronic paper terminal or the like is able to be distinguished.

Further, when the image output apparatus searched as described above is the image output apparatus 10, the search portion 223 obtains state information of the apparatus from the image forming apparatus 10. The state information includes information indicating the image forming apparatus 10 is in a ready state (printable), information indicating that operation is performed in an energy saving mode, and information indicating that operation is in automatic power shutoff.

The energy saving mode is a mode, for example, in which when a predetermined time is elapsed in a standby state, a heater temperature of a fixing portion is automatically lowered so as to suppress power consumption. Moreover, the automatic power shutoff is a mode in which when a predetermined time is elapsed in a standby state, the power of the heater of the fixing portion is turned off so as to suppress power consumption. Obtaining of the state information of the device by the search portion 223 of the information processing apparatus 20 is able to be executed by MIB (Management Information Base), SOAP (Simple Object Access Protocol) communication or the like.

As another example of the state information, information indicating an operating state of the image output apparatus which is in standby, in operation, in trouble, or the like, may be obtained.

The storage portion 24 is storing means comprised of an HDD, various memories and the like which stores the device information or the state information that are searched by the search portion 223 as search results.

The presentation portion 225 of the control portion 22 presents the device information or the state information that are searched by the search portion 223 using the search portion 223. Specifically, device information of the image output apparatus which is able to perform image output in the output system selected by the selection portion 222 and state information of the image output apparatus are presented by the user interface 23. In this case, it is general to perform presentation by displaying the device information and the state information on a display screen of the user interface 23, however, for a sight-impaired user, such information may be presented by means of voice.

The acceptance portion 226 of the control portion 22 is to accept operation input from a user using the user interface 23, and accepts operation input such as selection of an image output apparatus that is a transmission destination of common format data, selection of an output system of image data, input of a condition of image output in the selected output system, and execution instruction of the image output.

The preview display editing portion 227 of the control portion 22 creates a preview image of common format data generated by the common format data generation portion 221 to be displayed on the display portion of the user interface 23. Further, the preview display editing portion 227 performs replacement/editing of a page for a display screen of the preview image according to the operation input by the user.

When an image output instruction by the user operation is accepted by the acceptance portion 226, the command generation portion 224 generates a command to cause the image output apparatus to execute output processing on the accepted output condition. The generated command is transmitted with the common format data to the selected image output apparatus.

The communication portion 21 transmits the common format data which is generated by the common format data generation portion 221 and the command generated by the command generation portion 224 to the image output apparatus that is selected as the transmission destination via the network 50. For transmission of the common format data and the command, LPR (Line Printer daemon protocol), FTP (File Transfer Protocol) or the like may be used.

The image forming apparatus 10 is provided with a communication portion 11, a control portion 12, a user interface (I/F) 13, a storage portion 14 and a print engine 15. The control portion 12 has a command analysis portion 121, an image output processing portion 122 and a response portion 123. The control portion 12 has, as hardware, an arithmetic processing unit such as a CPU, and a memory such as a ROM, RAM or the like, and reads out and executes a program stored in the memory so as to realize various functions of the above control portion 12.

The communication portion 11 receives the common format data and the command that are transmitted from the information processing apparatus 20. Further, when transmission of image data is instructed as output processing of the image data, the image data is transmitted to the specified destination.

The command analysis portion 121 of the control portion analyzes a command transmitted from the information processing apparatus 20 and judges a function used for output processing of the image data. For example, a judgment is made on a function used for the output processing of the image data is any of print, display, Fax transmission, I-Fax transmission, E-Mail transmission, FTP transmission and the like. The command analysis portion 121 decides, in the case where the function specified by the command is print, a setting condition of the print, and in the case where various transmission processing is specified by the command, decides a destination setting thereof and the like.

The image output processing portion 122 of the control portion 12 outputs image data in the received common format according to the setting decided by the command analysis portion 121. The image output processing portion 122 outputs, in the case where the specified output processing is print, to the print engine 15 the image data in the common format with the print setting condition decided by the command analysis portion 121.

Furthermore, the image output processing portion 122 converts, when the specified output processing is Fax transmission, I-Fax transmission or the like, the image data in the common format to data in a TIFF file, and transmits the data to the communication portion 11 with the information such as the destination setting. Further, when the specified output processing is E-Mail transmission, FTP transmission or the like, the image data in the common format is directly transmitted in the specified method, or when the data format for transmission is specified, the image data in the common format is converted into the image data in the specified data format and transmitted to the communication portion 11 with the information such as the destination setting.

The response portion 123 of the control portion 12 responds, when receiving an inquiry on a search from the search portion 223 of the information processing apparatus 20 on the network 50, by reading out information on a name and an IP address of the apparatus, and a function supported by the apparatus. Moreover, for the search performed by the information processing apparatus 20, state information of the self apparatus is transmitted as a response. The state information is, for example, ready information indicating a printable state, information indicating that operation is performed in an energy saving mode, and information indicating that operation is in automatic power shutoff.

The storage portion 14 is a storage means comprised of an HDD and various memories, and stores the apparatus information such as a name and an IP address of the apparatus, a function included in the apparatus and the like. The apparatus information is read out as appropriate according to reading control of the response portion 123, so as to be transmitted to the information processing apparatus 20.

The user interface (I/F) 13 is comprised of a display portion and an operation input portion such as a keyboard or a mouse. Further, it may be configured by a touch panel in which the display portion and the operation input portion are integrated.

### <Processing Example for Displaying Network Device in Order of Power Consumption>

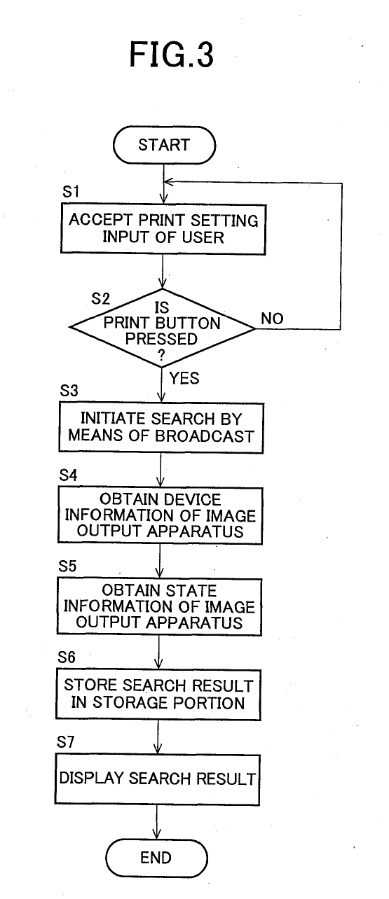

FIG. 3 is a flowchart for explaining an image output processing example by the image output system according to the present invention. In the image output system according to the present invention, in the case of outputting common format data generated by the information processing apparatus 20 by the image output apparatus connected to a network, it is possible to display the image output apparatus in ascending order of power consumed up until image output is able to be performed based on a search result of the information processing apparatus 20. The state where image output is able to be performed refers to, in the case of the image forming apparatus, a state where image formation of image data is immediately able to be performed, and in the case of the image display apparatus, a state where image display is immediately able to be performed.

Here, at first, the information processing apparatus 20 accepts print setting input by a user (step S1). Then, whether or not a user presses a print button is determined (step S2). For example, determination is made on whether or not a user who creates an arbitrary document or the like with an application that is operated in the information processing apparatus 20 causes a print setting screen for performing print output to appear and performs print setting, and operates a print button to instruct execution of printing.

When the print button is pressed, the information processing apparatus initiates a search of an image output apparatus connected to the network by means of broadcast (step S3). Then, from the image output apparatus connected to the network, by means of MIB (Management Information Base) or SOAP (Simple Object Access Protocol) communication, device information such as a name, an IP address and function information capable of performing image output in a common format and the like is obtained (step S4). Next, the information processing apparatus 20 performs MIB or SOAP communication again with all the image output apparatuses based on the obtained device information, and obtains state information of the image output apparatus (step S5). The state information of the image output apparatus that is responded is then stored in the storage portion 24 in the information processing apparatus 20 as a search result (step S6), and the search result is displayed on the display potion of the user interface 23 (step S7).

That is, when the print button for executing print is operated, the search is executed for not only the image forming apparatus that performs print output but also for all the image output apparatuses including the image display apparatus, so that the search result is displayed on the display portion. Thereby, search for not only the image output apparatus but also for the image output apparatus including the image display apparatus is able to be executed from the print setting screen with which the user is familiar, thus capable of alleviating a burden on the user.

In the present example, when the image processing apparatus performs printing by using the image forming apparatus, for example, when the user performs print setting by a printer driver which realizes the function of the common format data generation portion 221 of the image processing apparatus, an appropriate image output apparatus according to the print setting is displayed.

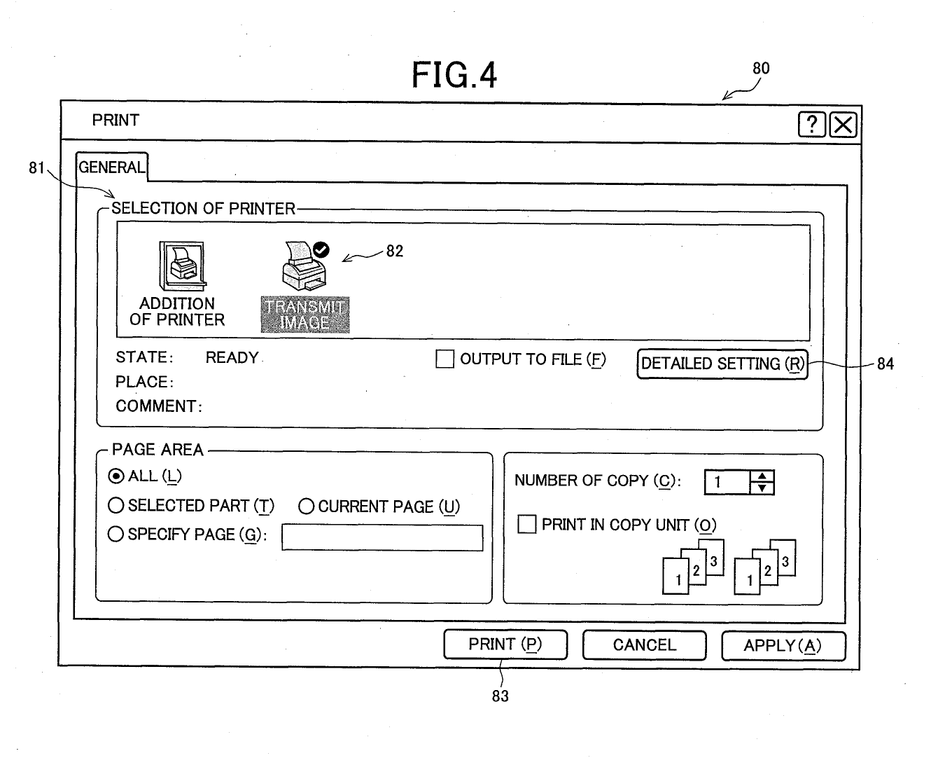

FIG. 4 is a diagram showing an example of a screen for activating the common format data generation portion of the image processing apparatus. A print setting screen 80 is a screen which appears when “PRINT” is specified in an arbitrary application. In “SELECTION OF PRINTER” 81 on the print setting screen 80, “TRANSMIT IMAGE” 82 is selected by user operation, and “PRINT” 83 is operated so as to be able to generate the common format data of the application data which is activated when the print setting screen 80 is caused to appear.

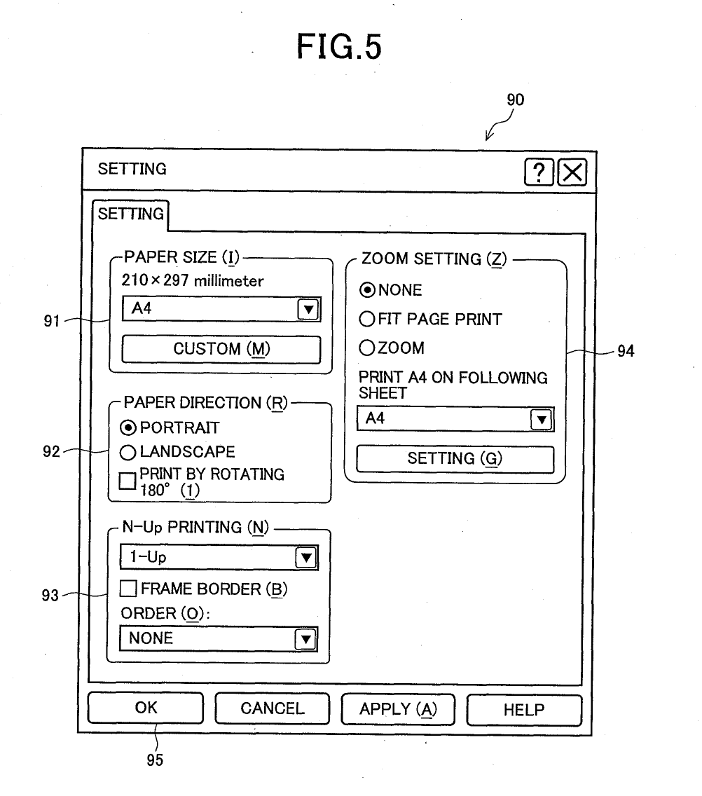

Further, on the print setting screen 80, the user operates “DETAILED SETTING” 84, and a dialogue 90 shown in FIG. 5 is thereby able to be displayed. It is possible to perform several settings from the dialogue 90 in creating the common format data. In the dialogue 90 of FIG. 5, respective settings including a sheet size 91, a sheet direction 92 and an N-up print 93, and a zoom setting 94 are able to be performed. When “OK” 95 is operated on this screen, the set content become effective and return to the print setting screen 80 of FIG. 4 is performed.

Additionally, on the dialogue 90 of FIG. 5, the detailed setting is performed and when change from a default is instructed, the common format data generation portion 221 generates common format data based on the content which details are set on the dialogue 90 of FIG. 5, when “PRINT” 83 in FIG. 4 is clicked. For example, when the N-Up print 93 is set to “2-Up”, the common format data that set to 2-Up is generated.

In this manner, the common format data generation portion 221 is able to be activated from the screen for printing the application data for generating the common format data.

Since a request of printing is made in the state of the application data being opened in many cases, the common format data generation portion 221 is activated from the screen for printing the application data, thus enabling an instruction to be given naturally.

Further, the print setting screen 80 shown in FIG. 4 is an instruction screen which is most frequently used compared with the screen for instructing transmission or the like. Accordingly, a user is able to select output processing other than printing from such a screen with which the user is familiar, which is useful to alleviate the burden on an unaccustomed user.

The search portion 223 of the information processing apparatus 20 initiates a search of the image output apparatus which is possible to be processed in the common format on the network 50, when the “PRINT” 83 in FIG. 4 is clicked or drag and drop a file of the application data, which is desired to be output, on an icon of the common format data generation portion 221 is performed.

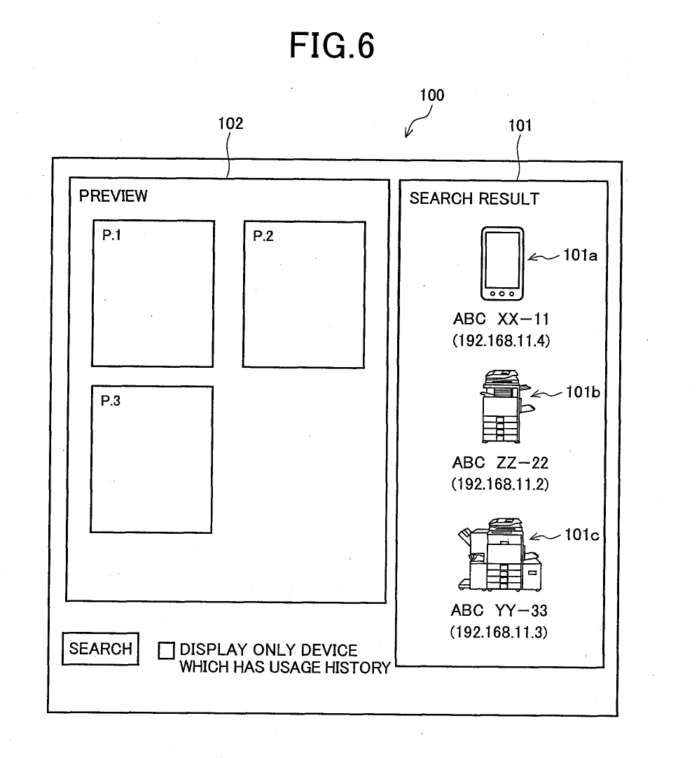

FIG. 6 is a diagram showing a display example of a search result by the information processing apparatus. The display screen 100 is displayed on the display portion of the user interface 23. In the preview display portion 102 on the display screen 100, a preview image of the common format data generated by the common format data generation portion 221 is displayed. The user is able to perform replacement of pages or editing of an image by checking the display state of the preview display portion 102.

As described above, the search portion 223 of the information processing apparatus 20 searches the image output apparatus connected to a network according to an image output system decided based on user operation and obtains device information and state information thereof. Then, the device information and the state information are displayed on the search result display portion 101 on the display screen 100. At the time, on the search result display portion 101, the image output apparatus is displayed in ascending order of power consumed up until image output is able to be performed based on the state information of the image output apparatus searched by the search portion 223. The image output apparatus may be displayed in the form of icons 101a to 101c. The user performs an operation to arbitrarily select the image output apparatus displayed on the search result display portion 101, so as to be able to execute the image output processing desired by the user by the selected image output apparatus.

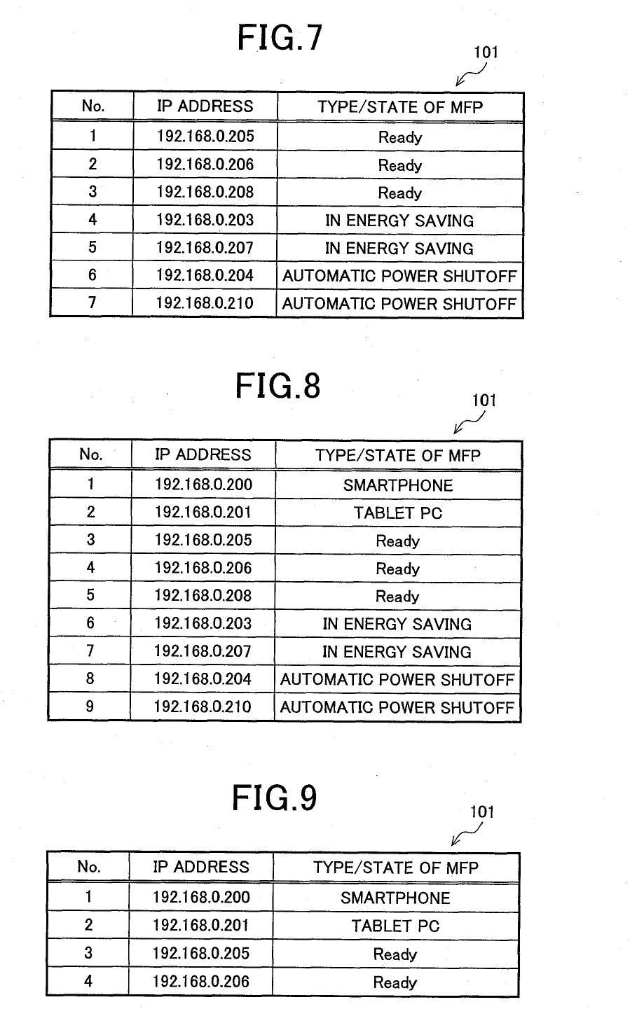

FIG. 7 is a diagram showing another display example of the search result by the image processing apparatus. The example is for displaying another example of the search result display portion 101 that is displayed on the display portion of the user interface 23, and the state information of the image output apparatus and the IP address of the image output apparatus are displayed in ascending order of the power consumed up until image output is able to be performed from among the image output apparatuses searched by the search portion 223.

For example, from among the image output apparatuses searched by the search portion 223, for one with the state information which is ready, image formation is able to be performed immediately, which is small in power consumed up until the image output (image formation) is able to be performed. Whereas, in the case of being in energy saving, a heater temperature of a fixing portion is reduced and the temperature of the fixing portion should be increased in order to make image output to be performed, so that the power consumption thereof is higher than that of the apparatus in the ready state. Moreover, in the case of automatic power shutoff, the power of the heater of the fixing portion is turned off so that its power consumption is still higher than that in energy saving.

Therefore, in such a case, as shown in FIG. 7, from the result of the state information, the image output apparatus in the ready state with the lowest power consumption is displayed in the top-most position, and subsequently, the image output apparatus in energy saving is displayed, and in the last place, the image output apparatus in the state of automatic power shutoff is displayed. Moreover, when a plurality of image output apparatuses in the same status of the state information are searched, the image output apparatuses may be displayed in the order of the quick response to the search request.

FIG. 8 is a diagram showing still another display example of the search result by the information processing apparatus. In the display example of FIG. 8, in search result display portion 101, not only the image forming apparatus with the print function, but also the smartphone or the tablet PC which are searched are displayed as the searched image output apparatus. In such a case, in the case where the image output system specified by the user in advance includes display output and print output of an image, the target of the search performed by the search portion 223 also includes the smartphone or the tablet PC. Then, the searched image output apparatuses are displayed in ascending order of power consumed up until image output is able to be performed.

Here, when the image output apparatus is the smartphone or the tablet PC, the type of the device is displayed, and when the image output apparatus is the image forming apparatus, state information thereof is displayed. Additionally, an IP address for each image output apparatus is displayed. The smartphone or the tablet PC has the lower power consumed up until image output, and the display order thereof thus goes up to an upper level. Therefore, for example, the smartphone, the tablet PC, the image forming apparatus in a ready state, the image forming apparatus in energy saving, and the image forming apparatus in automatic power shutoff are displayed in this order.

Further, in the display example of the search result display portion 101 in FIG. 8, the display state of the image forming apparatus which is not able to print out image data immediately may be explicitly changed. For example, for No. 6 to No. 9 on the search result display portion 101 of FIG. 8, the image forming apparatuses in energy saving or in automatic power shutoff are displayed. When operating in such operation modes, the image forming apparatuses need to increase the temperate of the fixing portion and thus not able to perform image formation immediately. Therefore, these display states are changed explicitly so that the user is able to confirm such states without fail. For example, the image forming apparatuses in energy saving or in automatic power shutoff may be displayed in red boldface. The explicit display change is not limited thereto, and various display methods may be set.

FIG. 9 is a diagram showing still another example of the search results by the information processing apparatus. In the display example of FIG. 9, in search result display portion 101, the image forming apparatuses with the print function as well as the smartphone and the tablet PC are displayed as the searched image output apparatus. In this case, for the image forming apparatus, from among the image forming apparatuses searched by the search portion 223, only the image forming apparatuses with the state information indicating as ready are displayed. Also in this case, the power consumed up until image output is able to be performed is displayed in ascending order. Thereby, the user is able to confirm and select only the image output apparatus which is capable of immediately performing image output.

### <Processing to Display Device in Order of Power Consumption Using Past Usage History>

In another embodiment of the image output system according to the present invention, the information processing apparatus 20 uses a usage history of the image output apparatus to display the image output apparatus.

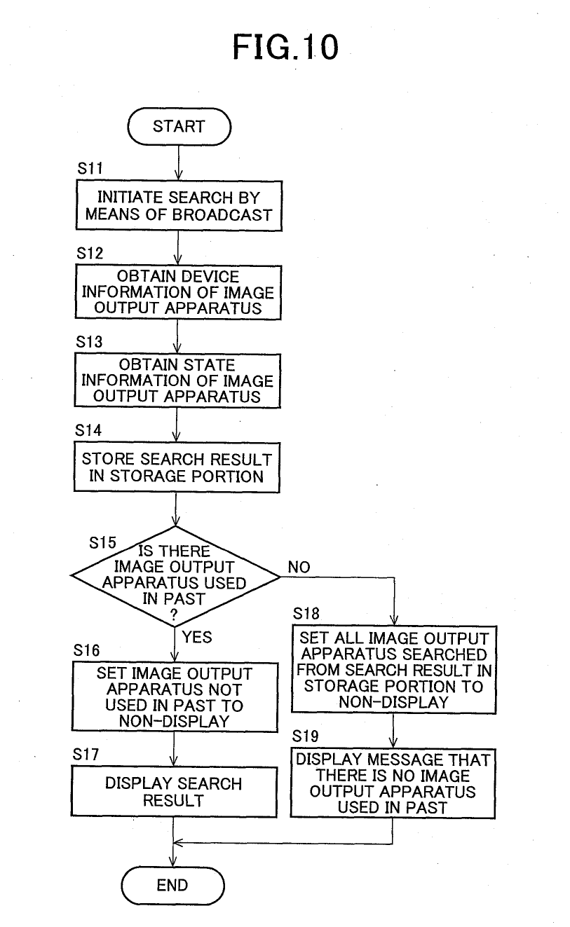

FIG. 10 is a flowchart for explaining another processing example of the image output system according to the present invention. The processing at step S11 to S14 is the same as that at the steps S1 to S4 in the flowchart of FIG. 3 described above. That is, first, the information processing apparatus 20 initiates a search of the image output apparatus connected to a network by means of broadcast (step S11), then, from the image output apparatus connected to the network by means of MIB or SOAP communication, device information such as a name, an IP address and function information capable of performing image output in a common form is obtained (step S12). The information processing apparatus 20 then performs MIB or SOAP communication again with all the image output apparatuses based on the obtained device information, and obtains the state information of the image output apparatus (step S13), and the state information of the responded image output apparatus is stored in the storage portion 24 in the information processing apparatus 20 as a search result (step S14).

Next, as a feature of the present embodiment, the information processing apparatus 20 refers to a past usage history of the storage portion 24, and distinguishes whether there is an image output apparatus which has been used for image output processing in the past from among the image output apparatuses searched this time (step S15).

When there is the image output apparatus searched this time in the usage history, the image output apparatus which has not been used in the past is set to non-display among the searched image output apparatuses (step S16), and a search result is displayed in such a state (step S17). Further, when there is no image output apparatus searched this time in the usage history, all the searched image output apparatuses are set to non-display (step S18), and a message is displayed that there is no image output apparatus which has been used in the past (step S19).

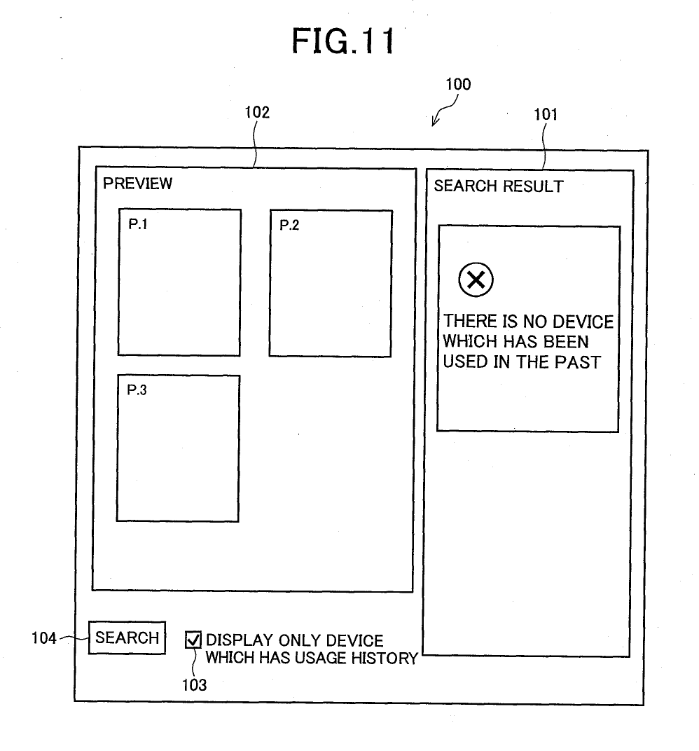

FIG. 11 is a diagram showing still another display example of the search result of the information processing apparatus. The display screen 100 displayed on the user interface 23 is the same as that shown in FIG. 6 as described above. In the case of the present example, a check box 103 for instructing that “DISPLAY ONLY DEVICE WHICH HAS USAGE HISTORY” is checked by user operation and the operation for pressing a search button 104 is performed, so that the search result in view of the past usage history is displayed on the search result display portion 101.

Then, when there is no image output apparatus searched this time in the past usage histories, a message that “THERE IS NO DEVICE WHICH HAS BEEN USED IN THE PAST” is displayed on the search result display portion 101. In this manner, in this example, when image output desired by the user is performed, only the image output apparatus which has been performed image output processing in the past is able to be displayed selectively. Thereby, the user is able to easily select the image output apparatus which has been used in the past and which the user is familiar with, thus being able to obtain improved convenience.

<Processing to Display Device in Order of Power Consumption by Distinguishing Image Forming Apparatus from Image Display Apparatus>

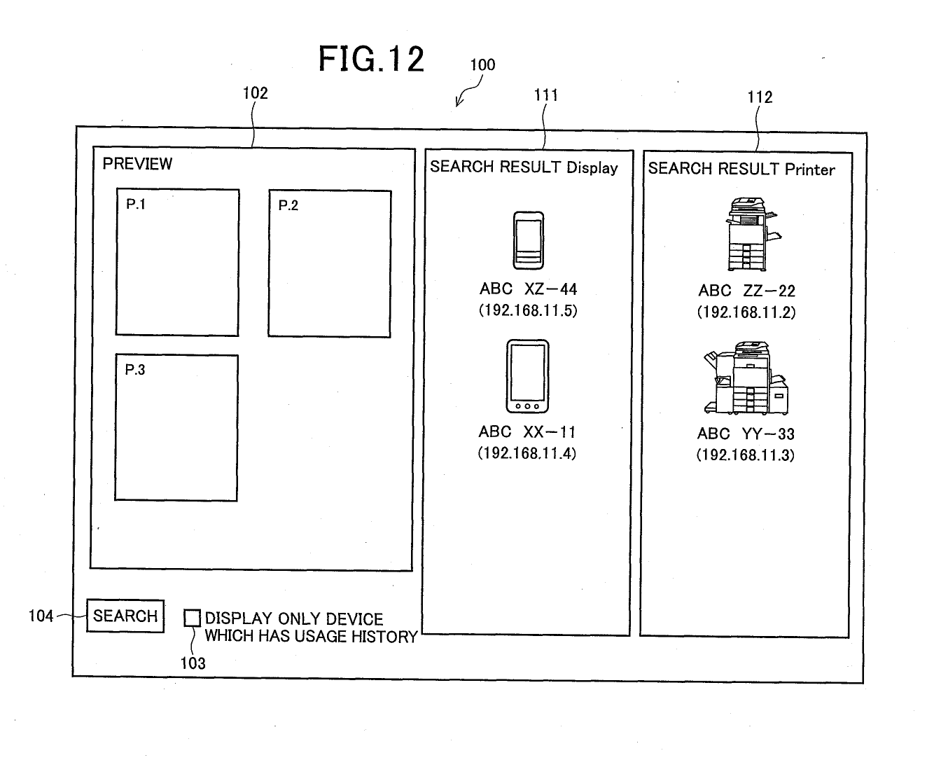

FIG. 12 is a diagram showing still another display example of the search result by the information processing apparatus. On the display screen 100 displayed on the user interface 23, two search result display portions 111 and 112 are set, and whether the searched image output apparatus is the image forming apparatus such as an MFP and the image display apparatus such as a tablet PC or a smartphone are distinguished to be displayed. Here, in the first search result display portion 111, the image display apparatus such as the tablet PC or the smartphone is displayed, and in the second search result display portion 112, the image forming apparatus such as the MFP is displayed. In both the search result display portions 111 and 112, the apparatuses are displayed in ascending order of the power consumed up until image output is able to be performed.

Such a display method enables display of the image output apparatus by the output system such as image formation or image display, thus being capable of improving convenience for a user.

### <Processing to Display Operation State Information of Image Output Apparatus>

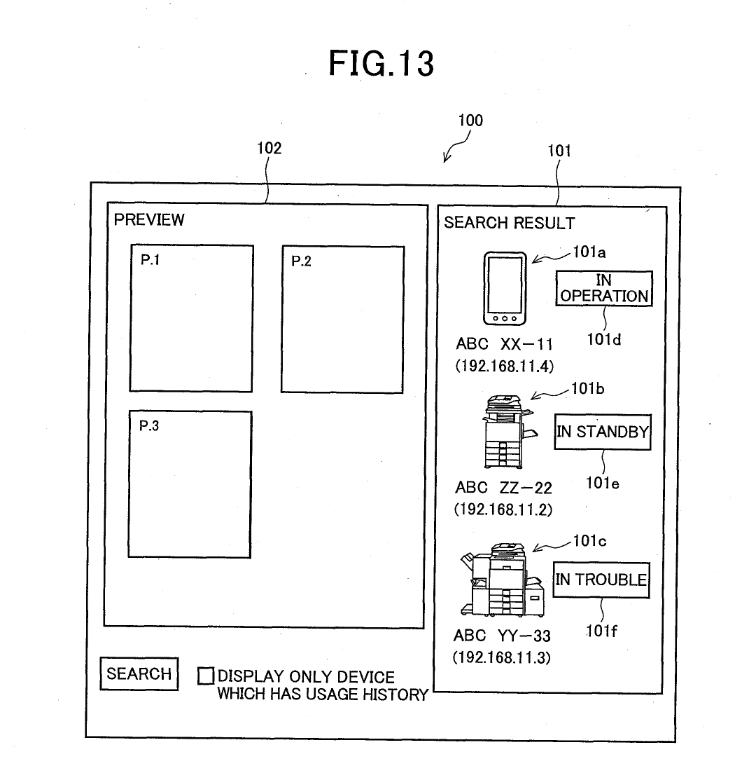

FIG. 13 is a diagram showing still another display example of the search result by the information processing apparatus. In the example, as with the example of FIG. 6, on the search result display portion 101, the image output apparatuses are displayed in ascending order of the power consumed up until the image output is able to be performed based on the state information of the image output apparatus searched by the search portion 223. Then, further in the example, operation state information indicating that the image output apparatus is in any of the state in operation, in standby, or in trouble, for example, is obtained as the state information of the image output apparatus. In the information processing apparatus 20, such operation state information is obtained from the searched image output apparatus and operation state information 101d to 101f is displayed with icons 101a to 101c of the image output apparatuses displayed on the search result display portion 101. The user performs an operation to arbitrarily select the image output apparatus displayed on the search result display portion 101, thereby being capable of causing the selected image output apparatus to execute the image output processing desired by the user.

### <Processing to Display Image Output Apparatus in Order of Power Consumption and in Order of Remaining Battery Amount>

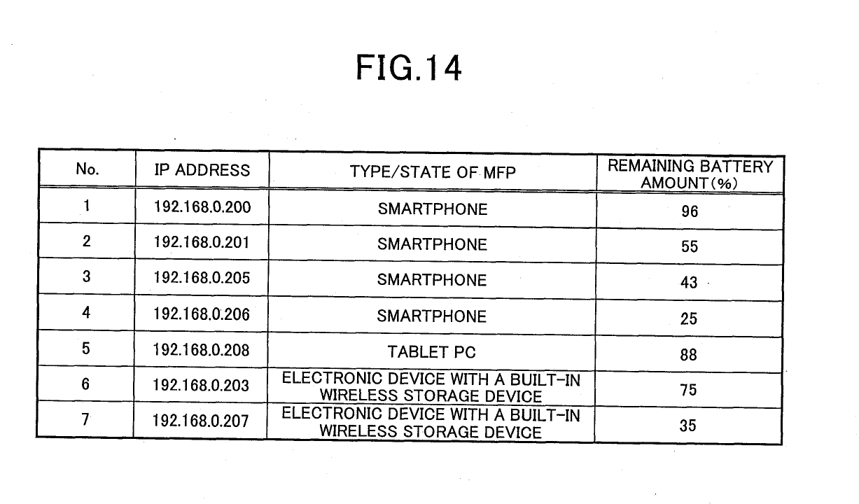

FIG. 14 is a diagram showing still another display example of the search result by the information processing apparatus. In the example, when the searched image output apparatus is a portable type display apparatus such as the smartphone, the tablet PC or the electronic device with a built-in wireless storage device, the image output apparatus is displayed in ascending order of the power consumed up until image output (image display, in this case) is able to be performed, however, at the time, in the case where there are a plurality of devices with the same amount of power consumed up until the image output, such a display order is brought into the order of a remaining battery amount.

For example, as shown in FIG. 14, it is assumed that the smartphone, the tablet PC and the electronic device with a built-in wireless storage device are searched. Here, the power consumed up until image display of image data is performed is arranged in the order of the smartphone, the tablet PC and the electronic device with a built-in wireless storage device. In some cases, there may be, of course, a difference in the power consumed up until image display between the smartphones according to the model, however, it is assumed that the power consumption is the same in the same type of devices here.

In this case, when the devices are displayed in ascending order of power consumed up until image output, the smartphone, the tablet PC and the electronic device with a built-in wireless storage device are arranged in this order, and when a plurality of the same devices are displayed, the image output apparatuses are displayed in descending order of the remaining battery amount among the devices. The information processing apparatus obtains battery remaining amount information as one of the state information from the searched device for use in controlling the display order. For example, in the example of FIG. 14, four smartphones and two electronic devices with a built-in wireless storage device are searched and these smartphones and electronic devices with a built-in wireless storage device are displayed in descending order of the remaining battery amount, respectively.

### <Processing to Display Image Output Apparatus in Order of Power Consumption and in Order of Screen Size>

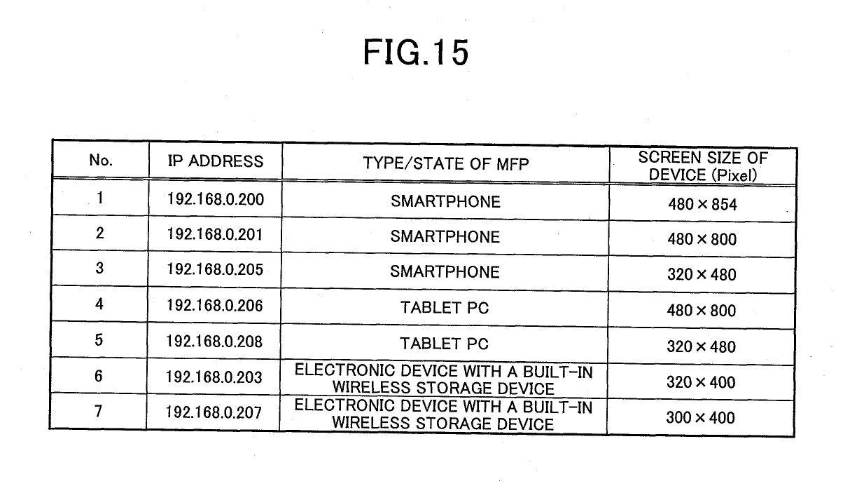

FIG. 15 is a diagram showing still another display example of the search result of the information processing apparatus. In the example, when the searched image output apparatus is a portable type display apparatus such as the smartphone, the tablet PC or the electronic device with a built-in wireless storage device, the image output apparatus is displayed in ascending order of the power consumed up until image output (image display, in this case) is able to be performed, however, at the time, in the case where there are a plurality of devices with the same amount of power consumed up until image output, such a display order is brought into the order of a screen size.

For example, as shown in FIG. 15, it is assumed that the smartphone, the tablet PC and the electronic device with a built-in wireless storage device are searched. Here, the power consumed up until image display of image data is performed is arranged in the order of the smartphone, the tablet PC and the electronic device with a built-in wireless storage device. In some cases, there may be, of course, a difference in the power consumed up until image display between the smartphones according to the model, however, it is assumed that the power consumption is the same in the same type of devices here.

In this case, when the devices are displayed in ascending order of power consumed up until image output, the smartphone, the tablet PC and the electronic device with a built-in wireless storage device are arranged in this order, and when a plurality of the same devices are displayed, the image output apparatuses are displayed in descending order of the screen size in a case where the screen size is different among the devices. The information processing apparatus obtains screen size information as one of the state information from the searched device for use in controlling the display order. For example, in the example of FIG. 15, three smartphones and two electronic devices with a built-in wireless storage device are searched and these smartphones and electronic devices with a built-in wireless storage device are displayed in descending order of the screen size, respectively. In the example, although the screen size in a unit of the number of pixels is displayed as the screen size, the screen size is not limited to this unit, and may be information like indicating vertical length x horizontal length of the screen.

### <Processing to Display Device in Order of Power Consumption by Distinguishing Display Device of Image Output Apparatus>

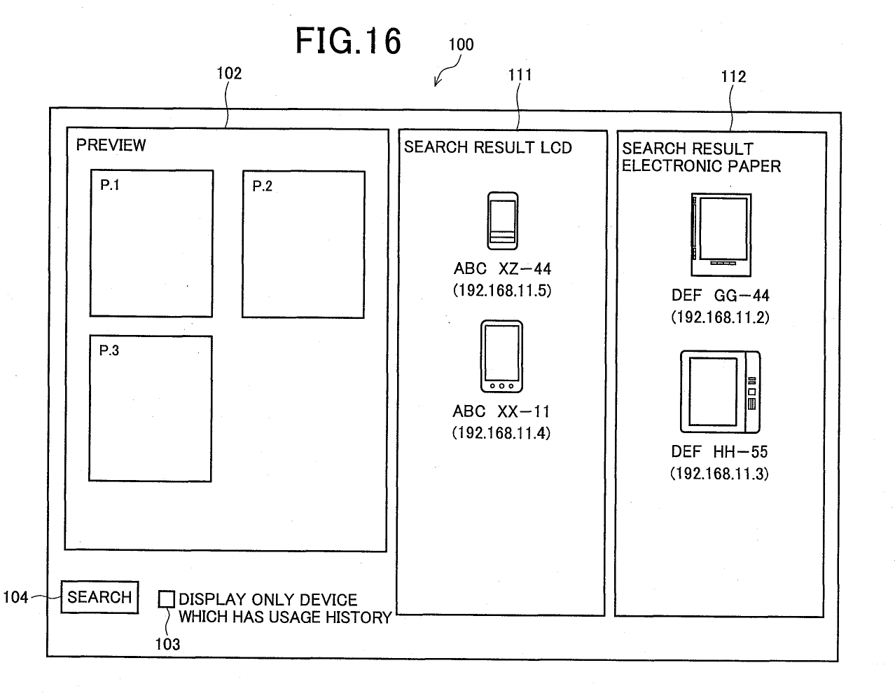

FIG. 16 is a diagram showing still another display example of the search result of the information processing apparatus. On the display screen 100 displayed on the user interface 23, two search result display portions 111 and 112 are set, and the searched image output apparatus distinguished by a type of a display device of the searched image output apparatus is displayed. Here, in the first search result display portion 111, the image display apparatus with the LCD (Liquid Crystal Display) as the display device is displayed, and in the second search result display portion 112, the image display apparatus with the electronic paper as the display device is displayed. The electronic paper may include one that performs display in various known systems such as a microcapsule system, an electronic liquid powder system, an electrophoresis system. Then, even in both of the search result display portions 111 and 112, then, the apparatuses are displayed in ascending order of the power consumed up until image output.

Such a display method enables display of the image output apparatus by the display device, thus being capable of improving convenience for a user.

<Processing to Display Only Image Forming Apparatus in Order of Power Consumption when Print Setting Input is Performed>

In the present example, when the image processing apparatus performs printing by using the image forming apparatus, for example, when the user performs print setting by a printer driver which realizes a function of the common format data generation portion 221 of the image processing apparatus, an appropriate image output apparatus according to the print setting is displayed.

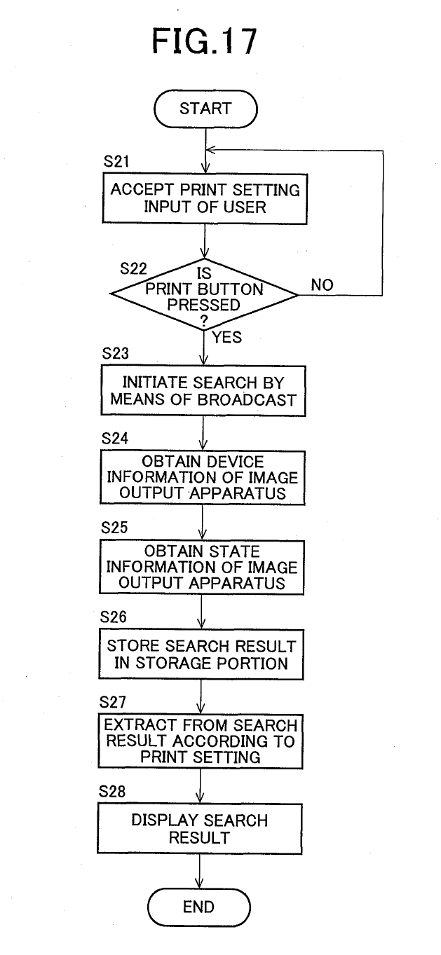

FIG. 17 is a flowchart for explaining another example of image output processing by the image output system according to the present invention. At first, the information processing apparatus 20 accepts print setting input by a user (step S21). Then, whether or not the user presses a print button is determined (step S22). For example, determination is made on whether or not the user who creates an arbitrary document or the like with an application that operates in the information processing apparatus 20 causes a print setting screen for performing print output to appear and performs print setting, and operates the print button to instruct execution of printing.

When the print button is pressed, the information processing apparatus initiates a search of the image output apparatus connected to a network by means of broadcast (step 523). Then, from the image output apparatus connected to the network, by means of MIB (Management Information Base) or SOAP (Simple Object Access Protocol) communication, device information such as a name, an IP address and function information capable of performing image output in a common format is obtained (step S24). Next, the information processing apparatus 20 performs MIB or SOAP communication again with all the image output apparatuses based on the obtained device information, and obtains state information of the image output apparatus (step S25).

The state information of the image output apparatus that is responded is then stored in the storage portion 24 of the information processing apparatus 20 as a search result (step S26). Next, from among the search results stored in the storage portion 24, a specific search result according to the print setting made at step S21 is extracted (step S27). For example, in FIG. 4, FIG. 5 or in other print setting, when printing multiple copies is set, N-UP printing is set, or predetermined post processing such as staple or punch is set, only the image forming apparatus is extracted from among the print results stored in the storage portion 24. Then, the extracted search result is displayed on the display portion of the user interface 23 (step S28).

That is, when the print button for executing printing is operated, the search is executed for not only the image forming apparatus that performs print out but also for all the image output apparatuses including the image display apparatus, and the specific image forming apparatus is extracted according to the print setting from among the searched results, and the extracted search result is displayed on the display portion. On the display screen of the search result, only the image forming apparatus extracted according to the print setting is displayed for the search result display portion 101 in FIG. 6, for example. In this case, the extracted image forming apparatus is displayed in ascending order of the power consumed up until image output.

Hereinabove, according to the present invention, it is possible to provide an information processing apparatus for searching a device which is able to perform image output and displaying in order of power consumed up until image output so as to allow a user to acknowledge a usable apparatus appropriately and use it for image output, and an image output system comprised of the information processing apparatus and an image output apparatus.

1. An information processing apparatus which is connectable to a plurality of image output apparatuses via a communication network, comprising:
a search portion for searching the image output apparatus connected to the communication network, and obtaining device information unique to the image output apparatus including function information indicating a function of image output processing executable by the image output apparatus and state information indicating a state of the image output apparatus;
a storage portion for storing a search result by the search portion;
a display portion for displaying the search result stored in the storage portion; and
a display control portion for controlling display of the display portion; wherein
the display control portion distinguishes power consumed up until image output is performed for each image output apparatus based on the device information and the state information obtained from the searched image output apparatus, and displays on the display portion information indicating the image output apparatuses in ascending order of the power consumption.

2. The information processing apparatus as defined in claim 1, further comprising an operation input portion for accepting operation input by a user, and a selection portion for selecting an output system of image data in accordance with operation input for the operation input portion, wherein
the search portion distinguishes the image output apparatus capable of performing image output in the selected output system based on the device information obtained from the image output apparatus connected to the communication network, and stores the distinguished result in the storage portion as a search result.

3. The information processing apparatus as defined in claim 1, wherein
the search portion searches, as search targets, an image forming apparatus for performing image formation and output of image data onto a recording medium, and an image display apparatus for performing display and output of image data on a display screen.

4. The information processing apparatus as defined in claim 3, further comprising a portion for transmitting the image data created by the information processing apparatus to the image forming apparatus connected via the communication network so that image formation is performed, wherein
the display control portion extracts, when a predetermined image forming condition is set for the portion for performing image formation, the image forming apparatus as the image output apparatus, and displays on the display portion the extracted image forming apparatus in ascending order of the power consumption.

5. An image output processing system comprised of the information processing apparatus as defined in claim 1 and the image output apparatus connected to the information processing apparatus via the communication network, wherein
the image output apparatus transmits, in response to a request transmitted from the information processing apparatus, device information unique to the image output apparatus including function information indicating a function of image output processing executable by the image output apparatus and state information indicating a state of the image output apparatus.

6. An image output processing system comprised of the information processing apparatus as defined in claim 2 and the image output apparatus connected to the information processing apparatus via the communication network, wherein
the image output apparatus transmits, in response to a request transmitted from the information processing apparatus, device information unique to the image output apparatus including function information indicating a function of image output processing executable by the image output apparatus and state information indicating a state of the image output apparatus.

7. An image output processing system comprised of the information processing apparatus as defined in claim 3 and the image output apparatus connected to the information processing apparatus via the communication network, wherein
the image output apparatus transmits, in response to a request transmitted from the information processing apparatus, device information unique to the image output apparatus including function information indicating a function of image output processing executable by the image output apparatus and state information indicating a state of the image output apparatus.

8. An image output processing system comprised of the information processing apparatus as defined in claim 4 and the image output apparatus connected to the information processing apparatus via the communication network, wherein
the image output apparatus transmits, in response to a request transmitted from the information processing apparatus, device information unique to the image output apparatus including function information indicating a function of image output processing executable by the image output apparatus and state information indicating a state of the image output apparatus.
